(19) United States
(12) Patent Application Publication
(10) Pub. No.: US 2004/0226128 A1
(43) Pub. Date: Nov. 18, 2004

(54) Ball joint and wiper system having the same

(75) Inventor: Yoshiyuki Sugiyama, Hamana-gun (JP)

Correspondence Address: POSZ & BETHARDS, PLC, 11250 ROGER BACON DRIVE, SUITE 10, RESTON, VA, 20190, US

(73) Assignee: ASMO CO., LTD.

(21) Appl. No.: 10/844,325

(22) Filed: May 13, 2004

(30) Foreign Application Priority Data
May 16, 2003 (JP) 2003-138957

(51) Int. Cl. B60S 1/16; B60S 1/18

(52) U.S. Cl. 15/250.31; 15/250.3; 403/122

(57) ABSTRACT

A boot is installed to a shaft portion of a ball pin and slidably engages a joint case to seal between the ball pin and the joint case. The boot includes a slidably engaging portion, a connecting portion and a flexible portion. The slidably engaging portion slidably engages the joint case. The connecting portion is attached to the shaft portion of the ball pin. The flexible portion flexibly connects between the slidably engaging portion and the connecting portion. The slidably engaging portion includes an arcuate section and a flange section. The arcuate section has an arcuate cross section on an inner peripheral side of the slidably engaging portion. The flange section projects on an outer peripheral side of the slidably engaging portion.

### CROSS REFERENCE TO RELATED APPLICATION

This application is based on and incorporates herein by reference Japanese Patent Application No. 2003-138957 filed on May 16, 2003.

### BACKGROUND OF THE INVENTION

1. Field of the Invention

The present invention relates to a ball joint and a wiper system and more particularly to a ball joint used in a vehicle wiper link mechanism and to a wiper system, which has such a ball joint.

2. Description of Related Art

A ball joint is provided at a connection of a link rod of a wiper system to rotatably connect the link rod to a corresponding component. In the connection of the link rod, grease is applied between a ball pin and a joint case of the ball joint. When the grease leaks from the joint case or when dust particles intrude into an interior of the joint case, substantial friction is generated in the ball joint. Such friction causes generation of noises. In order to address above disadvantage, a boot is installed between the ball pin and the joint case to limit the leakage of the grease or the intrusion of the dust particles.

Japanese Unexamined Patent Publication No. 63-76906 discloses one such boot, which includes an annular rib, an annular projection and a thin walled flexible portion. The annular rib is secured around a shaft portion of the ball pin. The annular projection is secured through engagement with an engaging portion of a groove formed in an outer peripheral surface of the joint case. The flexible portion connects between the annular projection and the rib. The flexible portion of the boot follows movement of the link rod and is thereby deformed, so that the annular projection and the rib are not substantially deformed and substantially maintain the original attached state. As described above, the annular projection of the boot always closely engages the engaging portion of the joint case, so that the boot can achieve effective sealing.

However, in the above ball joint, when the link rod is largely tilted, one side of the boot is pulled by the link rod. At that time, in order to limit disengagement between the annular projection and the engaging portion, the boot needs to be sufficiently large, disadvantageously resulting in an increase in a size of the ball joint.

Japanese Unexamined Utility Model Publication No. 1-106352 discloses another type of boot, which achieves sufficient sealing and has a small size. The boot includes an annular covering portion, a slidably engaging portion and a deformation absorbing portion. The annular covering portion is secured to a shaft portion of a ball pin. The slidably engaging portion has an arcuate cross section and slidably engages a joint case. The deformation absorbing portion connects between the slidably engaging portion and the covering portion. The slidably engaging portion of the boot is not secured to the joint case and slidably engages the joint case.

As described above, in the latter boot, the slidably engaging portion is not secured to the joint case. Thus, unlike the former boot, which has the annular projection, it is not required to prevent displacement of the engaged region between the boot and the joint case upon pulling of the one side of the boot by the link rod at the time of large tilting of the link rod, so that it is not required to increase the size of the boot.

Furthermore, in order to avoid accumulation of dust particles or the like at the slidably engaging portion, the latter boot, which achieves the sliding engagement, makes point contact with the joint case in the cross sectional view (actually, line contact along the entire perimeter of the joint case). The point contact increases the engaging pressure of the boot against the joint case to improve the sealing therebetween. As described above, in the latter ball joint, the size of the boot is not increased, and thereby the manufacturing costs are relatively low. Furthermore, effective sealing is achieved.

However, in the latter boot, which makes the sliding engagement, the slidably engaging portion of the boot has the arcuate cross section to achieve the point contact in the cross sectional view. Furthermore, the boot is made of an elastic material, such as a rubber material or an elastomer material, which has a relatively high friction coefficient. Thus, at the time of assembly, when the joint case is axially depressed against the ball pin, to which the boot has been installed, the slidably engaging portion engages an outer peripheral surface of the joint case. At this stage, when the joint case is further depressed, the slidably engaging portion, which has the arcuate cross section, is dragged by the joint case and is thus rolled along the outer peripheral surface of the joint case, so that the rolled slidably engaging portion is jammed between the rest of the boot and the joint case. Thus, the joint case cannot be appropriately installed to the ball pin, to which the boot has been installed. This will result in an increase in burden on assembly work and check operation. This jammed state is schematically illustrated in FIG. 10, which shows a previously proposed ball joint 130. In FIG. 10, a joint case 133 is depressed against a distal end of a ball pin 131, so that a slidably engaging portion 141 is rolled and is jammed between the rest of the boot 140 and the joint case 133, as illustrated by a solid arrow.

### SUMMARY OF THE INVENTION

The present invention addresses the above disadvantages. Thus, it is an objective of the present invention to provide a ball joint, which improves assembly of the ball joint and achieves effective sealing without increasing a size of the ball joint. It is another objective of the present invention to provide a wiper system having such a ball joint.

To achieve the objectives of the present invention, there is provided a ball joint for rotatably connecting between a first link element and a second link element. The ball joint includes a ball pin, a joint case and a boot. The ball pin is secured to the first link element at a base end of the ball pin. The joint case is secured to the second link element and is connected to a distal end of the ball pin in a manner that enables relative rotation between the first link element and the second link element. The boot is installed to the base end of the ball pin and slidably engages the joint case to seal between the ball pin and the joint case. The boot is tubular and includes a slidably engaging portion, a connecting portion and a flexible portion. The slidably engaging portion slidably engages the joint case. The connecting portion is attached to the base end of the ball pin. The flexible portion flexibly connects between the slidably engaging portion and the connecting portion and has a radial wall thickness smaller than that of the slidably engaging portion and that of the connecting portion. The slidably engaging portion includes an arcuate section and a flange section. The arcuate section has an arcuate cross section on an inner peripheral side of the slidably engaging portion. The flange section projects on an outer peripheral side of the slidably engaging portion.

To achieve the objectives of the present invention, there is provided a wiper system for wiping a windshield. The wiper system includes a plurality of link elements and at least one ball joint. Each of the at least one ball joint rotatably connects between a first corresponding one and a second corresponding one of the plurality of link elements. Each ball joint includes a ball pin, a joint case and a boot. The ball pin is secured to the first corresponding one of the link elements at a base end of the ball pin. The joint case is secured to the second corresponding one of the link elements and is connected to a distal end of the ball pin in a manner that enables relative rotation between the first corresponding one of the link elements and the second corresponding one of the link elements. The boot is installed to the base end of the ball pin and slidably engages the joint case to seal between the ball pin and the joint case. The boot is tubular and includes a slidably engaging portion, a connecting portion and a flexible portion. The slidably engaging portion slidably engages the joint case. The connecting portion is attached to the base end of the ball pin. The flexible portion flexibly connects between the slidably engaging portion and the connecting portion and has a radial wall thickness smaller than that of the slidably engaging portion and that of the connecting portion. The slidably engaging portion includes an arcuate section and a flange section. The arcuate section has an arcuate cross section on an inner peripheral side of the slidably engaging portion. The flange section projects on an outer peripheral side of the slidably engaging portion.

### BRIEF DESCRIPTION OF THE DRAWINGS

The invention, together with additional objectives, features and advantages thereof, will be best understood from the following description, the appended claims and the accompanying drawings in which:

FIG. 1 is a front view showing a structure of a wiper system according to an embodiment;

FIG. 2 is a descriptive cross sectional view of a ball joint of the embodiment;

FIG. 3 is a descriptive cross sectional view of a joint case of the embodiment;

FIG. 4 is a descriptive cross sectional view of a ball pin and a boot of the embodiment;

FIG. 5 is a partially enlarged cross sectional view of the boot of the embodiment;

FIG. 6 is a descriptive cross sectional view showing assembling of the ball joint of the embodiment;

FIG. 7 is a descriptive cross sectional view showing assembling of the ball joint of the embodiment;

FIG. 8 is a descriptive cross sectional view showing an operational state of the ball joint of the embodiment;

FIG. 9A is a partial enlarged cross sectional view showing a modification of the boot;

FIG. 9B is a partial enlarged cross sectional view showing another modification of the boot;

FIG. 9C is a partial enlarged cross sectional view showing a further modification of the boot; and

FIG. 10 is a descriptive partial cross sectional view showing a state of a previously proposed ball joint at the time of assembly.

### DETAILED DESCRIPTION OF THE INVENTION

An embodiment of the present invention will be described with reference to the accompanying drawings.

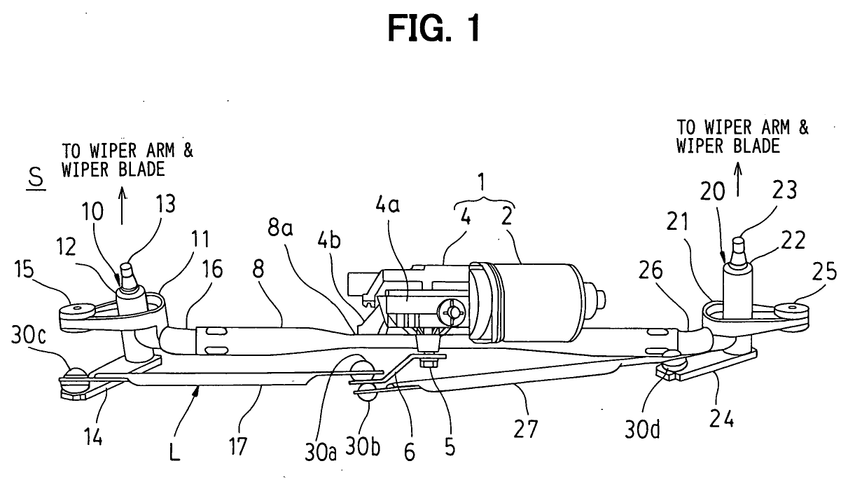

With reference to FIG. 1, a wiper system S of the present invention includes a linkage L, pivots 10, 20 and a frame 8. The linkage L conducts drive force of a wiper motor 1. The pivots 10, 20 are connected to the linkage L. The frame 8 connects between the pivot 10 and the pivot 20 and securely holds the wiper motor 1.

Each of the pivots 10, 20 includes a pivot holder 11, 21. The pivot holder 11 includes a tubular portion 12. The pivot holder 21 includes a tubular portion 22. Each of the tubular portions 12, 22 is shaped into a cylindrical shape. A pivot shaft 13 is received through and is rotatably supported by the tubular portion 12, and a pivot shaft 23 is received through and is rotatably supported by the tubular portion 22.

A pivot lever (a first pivot lever) 14 is secured to a lower end of the pivot shaft 13, and a pivot lever (a second pivot lever) 24 is secured to a lower end of the pivot shaft 23. When each pivot lever 14, 24 swings, the corresponding pivot shaft 13, 23 is rotated. Furthermore, a connecting hole 15, 25 is formed in a corner of each pivot holder 11, 21. The wiper system S is secured to a vehicle body by connecting bolts installed through the connecting holes 15, 25.

A joint shaft 16, 26 is formed in a side wall of each pivot holder 11, 21 on a side opposite from the connecting hole 15, 25. Each end of the frame 8 receives a distal end of the corresponding joint shaft 16, 26 and is joined with the distal end of the corresponding joint shaft 16, 26 by staking. Furthermore, a connecting portion 8a, which has a flat seat surface, is formed in a longitudinal intermediate part of the frame 8. The wiper motor 1, which serves as a drive source, is secured to the connecting portion 8a.

The wiper motor 1 includes a motor unit 2 and a gear unit 4, which are connected together. A pair of connecting legs 4b projects from a housing 4a of the gear unit 4. The connecting legs 4b are arranged on the connecting portion 8a of the frame 8 and are secured to the connecting portion 8a of the frame 8 by bolts and nuts. An output shaft 5 of the wiper motor 1 projects on a back surface side (a lower side in FIG. 1) of the housing 4a. A crank arm 6 of the linkage L is connected to a distal end of the output shaft 5.

The linkage L includes the crank arm 6 and wiper rods (first and second wiper rods) 17, 27. One end of the wiper rod 17 is connected to a distal end of the crank arm 6 through a ball joint (a first ball joint) 30a. Similarly, one end of the wiper rod 27 is connected to the distal end of the crank arm 6 through another ball joint (a second ball joint) 30b. The wiper rod 17 and the crank arm 6 are connected to each other through the ball joint 30a, which is arranged at an upper surface of the distal end of the crank arm 6. The wiper rod 27 and the crank arm 6 are connected to each other through the ball joint 30b, which is arranged at a lower surface of the distal end of the crank arm 6.

The other end of the wiper rod 17 is connected, through another ball joint (a third ball joint) 30c, to the pivot lever 14 of the pivot shaft 13, which is supported by the pivot holder 11. Furthermore, the other end of the wiper rod 27 is connected, through another ball joint (a fourth ball joint) 30d, to the pivot lever 24 of the pivot shaft 23, which is supported by the pivot holder 21. It should be noted that the crank arm 6, the wiper rods 17, 27 and the pivot levers 14, 24 serve as link elements of the present invention.

As described above, in the wiper system S, when the wiper motor 1 is driven to rotate the crank arm 6, drive force is conducted to each of the pivot shafts 13, 23 from the crank arm 6 through the corresponding wiper rod 17, 27 and the corresponding pivot lever 14, 24, so that the pivot shafts 13, 23 are synchronously rotated.

A distal end of each pivot shaft 13, 23 is connected to a corresponding wiper arm (not shown), to which a wiper blade is connected. When each pivot shaft 13, 23 is rotated, the corresponding wiper arm and the corresponding blade are swung reciprocably within a predetermined range to wipe raindrops or the like on a windshield.

Next, the ball joints 30a-30d of the present invention will be described. Here, only the ball joint 30c, which connects between the pivot lever (a first link element) 14 and the wiper rod (a second link element) 17, will be described in greater detail. However, it should be noted that the other ball joints 30a, 30b, 30d have a structure similar to that of the ball joint 30c and thus will not be described further for the sake of simplicity.

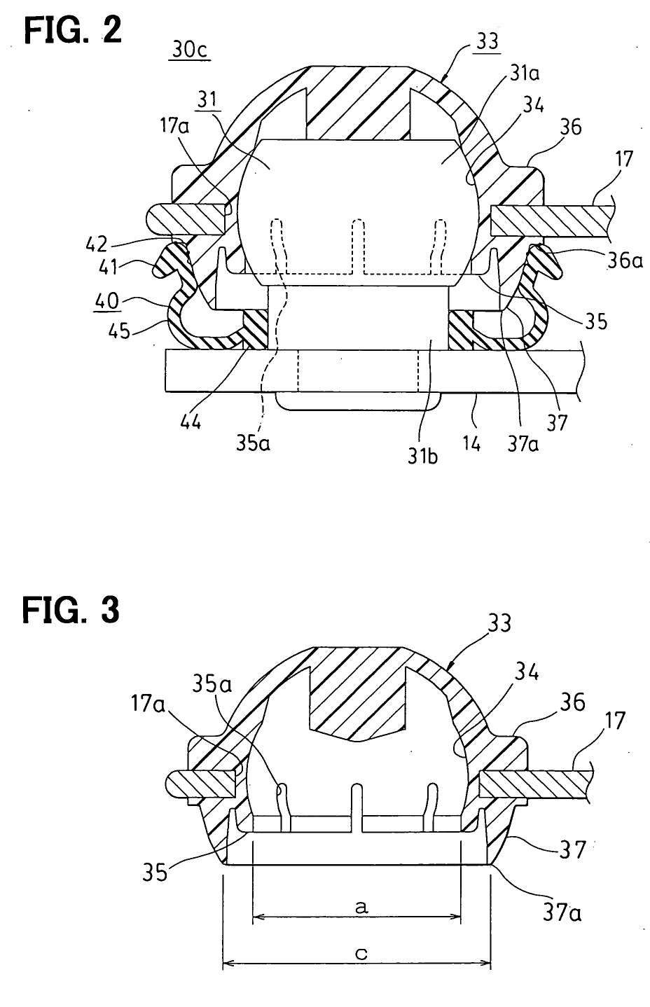

As shown in FIG. 2, the ball joint 30c includes a ball pin 31, a joint case 33 and a boot 40. The ball pin 31 is secured to the pivot lever 14. The joint case 33 is provided in the wiper rod 17. The boot 40 is installed to a shaft portion 31b of the ball pin 31, which is located at a base end of the ball pin 31. Furthermore, the boot 40 slidably engages the joint case 33 to seal between the ball pin 31 and the joint case 33. In the ball joint 30c, the joint case 33 is installed to the ball pin 31, so that the wiper rod 17 and the pivot lever 14 are rotatably connected to one another.

As shown in FIG. 3, the joint case 33, which is made of synthetic resin, is integrally formed by insert molding in a hole 17a provided in the wiper rod 17. The joint case 33 includes an installation recess 34, a lip portion 35, an annular securing portion 36 and a seal wall 37. The ball pin 31 is installed to the installation recess 34. The lip portion 35 extends downwardly from the installation recess 34. The securing portion 36 clamps the wiper rod 17 in the vertical direction. The seal wall 37 projects downwardly from the securing portion 36 and surrounds the installation recess 34 and the lip portion 35. A predetermined space is formed between an outer peripheral surface of the lip portion 35 and an inner peripheral surface of the seal wall 37.

The lip portion 35 serves as an installation inlet for installing the ball pin 31 into the joint case 33 and includes a plurality of slits 35a. The slits 35a extend generally in an axial direction of the ball pin 31. Furthermore, the slits 35a are arranged one after the other in a circumferential direction of the lip portion 35. When the ball pin 31, which has an outer diameter “b” larger than an inner diameter “a” of the lip portion 35, is installed in the joint case 33, the lip portion 35 is resiliently outwardly flexed toward the space formed between the lip portion 35 and the inner peripheral surface of the seal wall 37 to allow easy installation of the ball pin 31 into the joint case 33. An outer diameter “c” of a lower opening end 37a of the seal wall 37 is set to be larger than the outer diameter “b” of the ball pin 31.

In a state where the joint case 33 is resiliently fitted to the ball pin 31, the installation recess 34 slidably engages a bulb-shaped portion 31a of the ball pin 31, which is located at a distal end of the ball pin 31. Furthermore, the ball joint 30c connects between the wiper rod 17 and the pivot lever 14 in a relatively rotatable manner.

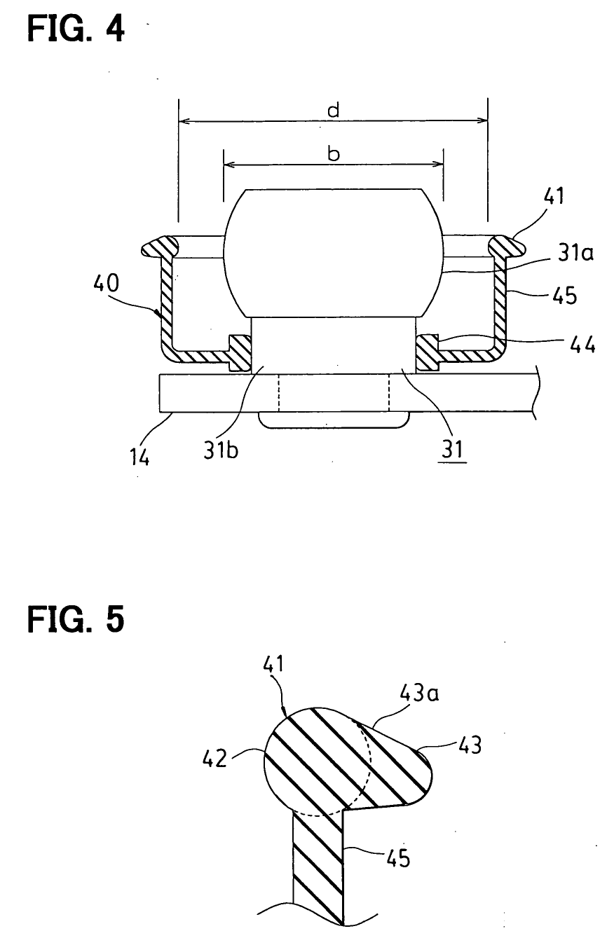

An outer peripheral surface of the seal wall 37 extends downwardly from a radially inner end of a lower annular surface 36a of the securing portion 36. An outer diameter of the seal wall 37 is progressively reduced from the securing portion 36 toward the opening end 37a. In a natural relaxed state, an inner diameter of an arcuate section 42 of a slidably engaging portion 41 of the boot 40 is set to a predetermined value “d” (FIG. 4).

An outer diameter (the outer diameter “c” of the opening end 37a) of the lower end of the seal wall 37 is set to be smaller than the inner diameter “d” of the arcuate section 42. An outer diameter of the securing portion 36 side end of the seal wall 37 is set to be larger than the inner diameter “d” of the arcuate section 42. Thus, upon installation of the ball joint 30c, the slidably engaging portion 41 of the boot 40 engages the outer peripheral surface of the seal wall 37 to seal between the joint case 33 and the ball pin 31.

FIG. 4 shows a state where the boot 40 is installed to the ball pin 31. As shown in FIG. 4, the ball pin 31 includes the cylindrical shaft portion 31b and the bulb-shaped portion 31a formed in the distal end of the shaft portion 31b. A base end of the shaft portion 31b is projected through an end of the pivot lever 14 and is joined to the end of the pivot lever 14 by staking. The boot 40, which is made of an elastic material, such as a rubber material or an elastomer material, is installed to the shaft portion 31b of the ball pin 31 and resiliently engages the shaft portion 31b of the ball pin 31. The boot 40 of the present embodiment is made of acrylonitrile butadiene rubber (NBR).

The boot 40 is formed into a tubular body and includes the annular slidably engaging portion 41, an annular connecting portion 44 and a thin walled flexible portion 45. A distal end of the slidably engaging portion 41 slidably engages the joint case 33. A base end of the connecting portion 44 is connected to the shaft portion 31b of the ball pin 31. The flexible portion 45 connects between the slidably engaging portion 41 and the connecting portion 44 and has flexibility. Furthermore, the flexible portion 45 has a radial wall thickness smaller than that of the slidably engaging portion 41 and that of the connecting portion 44. FIG. 5 is an enlarged view of the slidably engaging portion 41.

The slidably engaging portion 41 includes the arcuate section 42 and a flange section 43. The arcuate section 42 has an arcuate cross section and is located at a radially inner part, i.e., an inner peripheral side of the slidably engaging portion 41, and the flange section 43 projects radially outwardly at a radially outer part, i.e., at an outer peripheral side of the slidably engaging portion 41. In FIG. 5, a dotted line indicates an imaginary arc, which has a radius of curvature that coincides with that of an arcuate surface of the arcuate section 42 and corresponds to the slidably engaging portion of the prior art boot. The arcuate section 42 of the slidably engaging portion 41 is the portion that slidably engages the joint case 33. In the case of FIG. 5, the entire inner peripheral surface of the slidably engaging portion 41 forms the arcuate section 42. However, the present invention is not limited to this arrangement. For example, a lower part of the arcuate section 42 shown in FIG. 5 can be formed as a recess or a planar surface to form the arcuate section 42 into a partially arcuately shaped section. That is, a part of the arcuate section 42, which does not slidably engage the joint case 33 during its operation, does not need to be arcuate. More specifically, with respect to the slidably engaging portion 41 of the present invention, the term “arcuate cross section” is intended to include the entirely arcuate cross section and also the partially arcuate cross section. Furthermore, as long as the arcuate section 42 makes point contact (or contact close to the point contact) with the joint case 33 in the cross sectional view, the arcuate section 42 is not required to have a shape that forms part of a true circle and can have a shape that forms part of, for example, an ellipse.

The flange section 43 is shaped such that an upper surface 43a of the flange section 43, which extends continuously from the arcuate section 42, is sloped downwardly toward a distal end of the flange section 43. However, the shape of the flange section 43 is not limited to this one. For example, the flange section 43 can be shaped such that the surface 43a extends generally perpendicular to the axial direction of the boot 40, i.e., extends generally perpendicular to the axial direction of the ball pin 31. Also, the flange section 43 can be shaped such that the surface 43a is sloped upwardly toward the distal end of the flange section 43. In the case of FIG. 5, the downwardly sloped upper surface 43a prevents accumulation of water on the upper surface 43a of the flange section 43 in the state where the slidably engaging portion 41 slidably engages the joint case 33. Furthermore, in the present embodiment, the surface 43a is a planar surface, which extends continuously from the arcuate surface of the arcuate section 42 and is tangent to an imaginary arc of the arcuate surface of the arcuate section 42. However, as long as the flange section 43 can engage the seal wall 37 at the time of assembly to act as a stopper, which limits rolling of the flange section 43, the surface 43a does not need to be the planar surface and can have a curved surface, which has a curvature, for example, greater than that of the arcuate section 42.

Next, assembly of the ball joint 30c will be described. First, the ball pin 31 is secured to the pivot lever 14, and the boot 40 is installed to the shaft portion 31b of the ball pin 31 (FIG. 4). Then, the joint case 33, which is formed integrally with the wiper rod 17, is urged downwardly against the ball pin 31 in the axial direction of the ball pin 31 to receive the bulb-shaped portion 31a of the ball pin 31 into the installation recess 34 of the joint case 33. At this time, the outer peripheral surface of the seal wall 37 resiliently engages the arcuate section 42 of the slidably engaging portion 41 of the boot 40 along the perimeter or circumference of the seal wall 37. As discussed above, the outer diameter “c” of the opening end 37a of the seal wall 37 is set to be smaller than the inner diameter “d” of the arcuate section 42 of the slidably engaging portion 41 of the boot 40. Thus, the arcuate section 42 of the slidably engaging portion 41 of the boot 40 can reliably engages the outer peripheral surface of the seal wall 37.

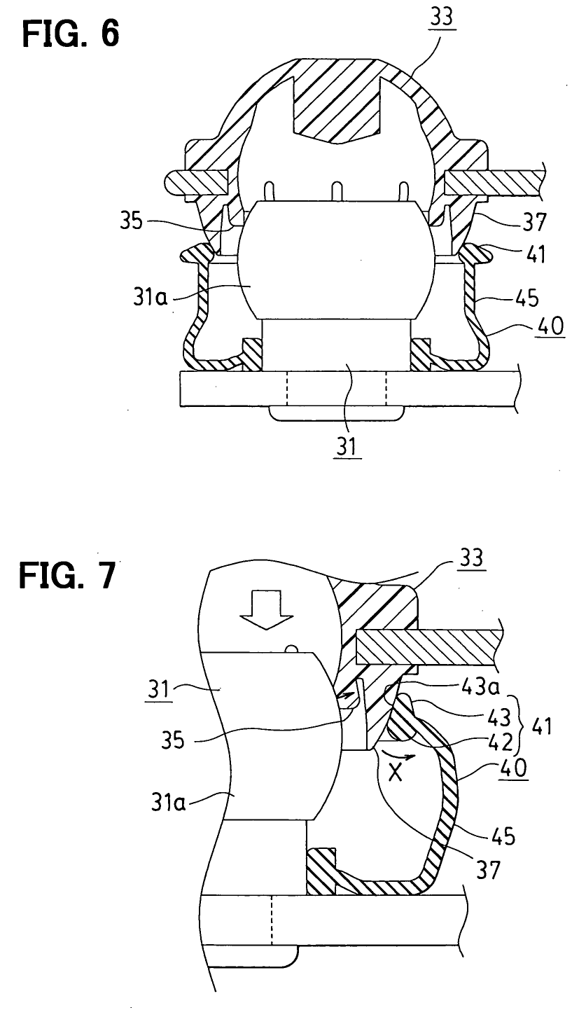

Furthermore, when the joint case 33 is depressed against the ball pin 31 such that the lip portion 35 of the joint case 33 engages the bulb-shaped portion 31a of the ball pin 31, as shown in FIG. 6, the slidably engaging portion 41 is urged downwardly by frictional force generated between the arcuate section 42 and the outer peripheral surface of the seal wall 37, so that the flexible portion 45 is flexed. At this stage, when the joint case 33 is further depressed, the lip portion 35 slidably engages the bulb-shaped portion 31a and is outwardly flexed to allow insertion of the bulb-shaped portion 31a into the lip portion 35. Simultaneously, the slidably engaging portion 41 receives rolling force in an inward rolling direction (a direction of X in FIG. 7) due to the frictional force generated between the arcuate section 42 and the outer peripheral surface of the seal wall 37.

When the slidably engaging portion 41 is rolled through a predetermined angle, the surface 43a of the flange section 43 engages the outer peripheral surface of the seal wall 37, as shown in FIG. 7, so that the surface 43a acts as the stopper, which limits further rolling of the slidably engaging portion 41. That is, upon engagement of the surface 43a with the outer peripheral surface of the seal wall 37, further rolling of the slidably engaging portion 41 in the direction of X requires an increase in an angle between the outwardly projected flange section 43 and the flexible portion 45. In the boot 40 of the present embodiment, the flange section 43, which is formed in the slidably engaging portion 41, improves the rigidity of the slidably engaging portion 41, which acts against the force that would otherwise cause the increase in the angle between the flange section 43 and the flexible portion 45.

Thus, this rigidity provides retaining force, which acts against the rolling force exerted in the direction of X and which tries to retain the natural state of the angle between the flange section 43 and the flexible portion 45. Thus, even when the joint case 33 is further depressed against the ball pin 31, the joint case 33 can be installed to the ball pin 31 without causing further rolling of the slidably engaging portion 41 by the seal wall 37. Thus, jamming of the slidably engaging portion 41 between the rest of the boot 40 and the seal wall 37 can be limited.

Upon installation of the joint case 33 to the ball pin 31, the slidably engaging portion 41 of the boot 40 tends to maintain its natural state and is thus urged in a diameter reducing direction, i.e., is urged inwardly in the radial direction toward the central axis of the ball pin 31. Furthermore, the flexible portion 45 is placed in the flexed state, and therefore the slidably engaging portion 41 of the boot 40 is also urged upwardly in the axial direction. Thus, as shown in FIG. 2, in the cross sectional view of the ball joint 30c, the arcuate section 42 of the slidably engaging portion 41 of the boot 40 makes point contact (or contact close to the point contact) with the outer peripheral surface of the seal wall 37 (line contact with the outer peripheral surface of the seal wall 37 along the entire perimeter of the outer peripheral surface of the seal wall 37) in the radial direction. Also, in the cross sectional view of the ball joint 30c, the arcuate section 42 makes point contact (or contact close to the point contact) with the annular surface 36a (line contact with the annular surface 36a along the entire perimeter of the annular surface 36a) in the axial direction.

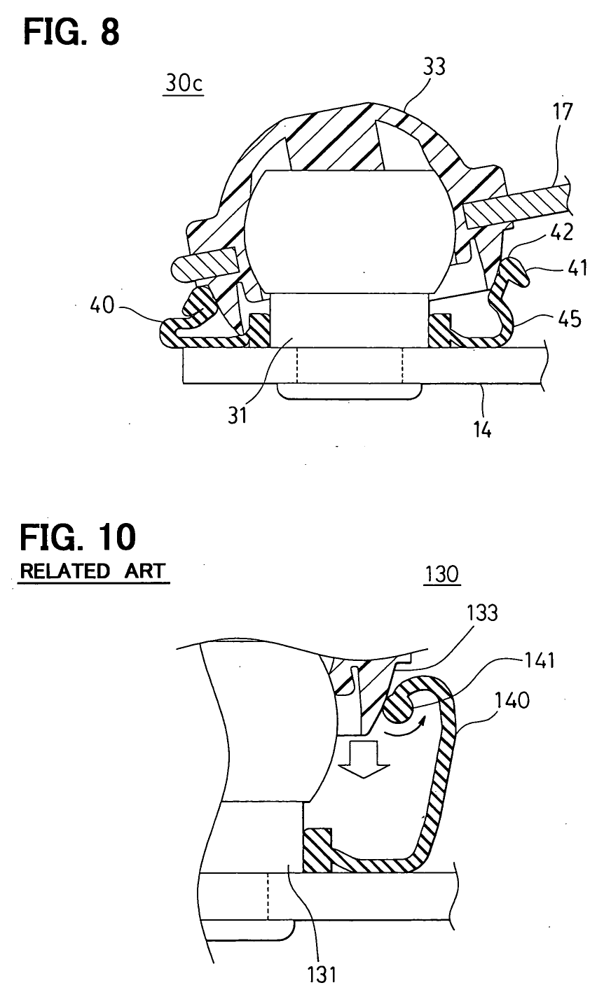

Even when the wiper rod 17 is tilted relative to the pivot lever 14 in a manner shown in FIG. 8 due to movement of the wiper rod 17, the boot 40 does not limit movement of the ball joint 30c and follows the movement of the ball joint 30c. More specifically, the flexible portion 45 of the boot 40 follows movement of the wiper rod 17 and is thus deformed. As a result, the arcuate section 42 of the slidably engaging portion 41 always slidably engages and makes point contact (or contact close to the point contact) with the outer peripheral surface of the seal wall 37 or the lower annular surface 36a of the securing portion 36 in the cross sectional view of the ball joint 30c.

The slidably engaging portion 41 makes the point contact (or the contact close to the point contact) with the joint case 33 (the line contact with the joint case 33 along the entire perimeter of the joint case 33) in the cross sectional view of the ball joint 30c. Thus, the engaging pressure of the slidably engaging portion 41 against the joint case 33 is increased to achieve effective sealing between the slidably engaging portion 41 and the joint case 33. As a result, it is possible to limit leakage of grease provided in an interior of the joint case 33. Also, it is possible to limit intrusion of foreign particles, such as dust particles, into the interior of the joint case 33. Furthermore, the slidably engaging portion 41 makes the point contact (or the contact close to the point contact) with the joint case 33 in the cross sectional view of the ball joint 30c. Thus, dust particles or the like are not accumulated in the slidably engaging portion 41.

The wiper system S is often arranged at a location adjacent to an outside air intake opening of an air conditioning system. Thus, when the air conditioning system takes the outside air, dust particles and water droplets are likely applied to the wiper system S along with the outside air. Even in such an environment, the ball joint 30c can achieve good sealing.

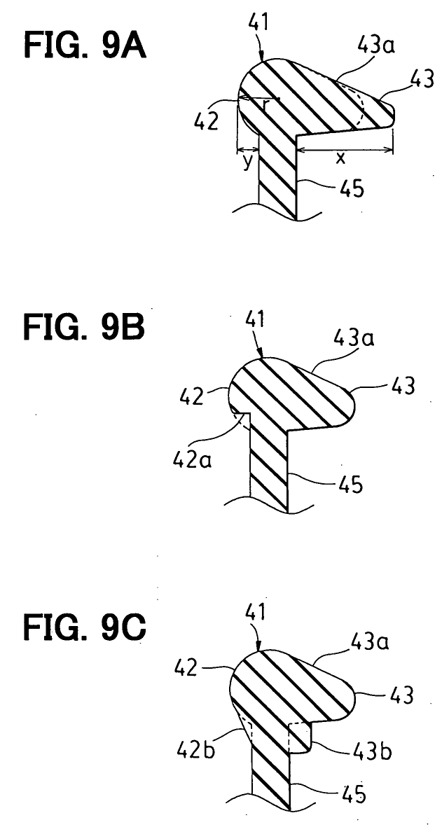

Next, FIGS. 9A-9C show modifications of the slidably engaging portion 41 of the boot 40. In the slidably engaging portion 41 of FIG. 9A, a radially outward extension of the surface 43a is longer than that of the slidably engaging portion 41 of FIG. 5 (the slidably engaging portion 41 of FIG. 5 being indicated by a dotted line in FIG. 9A). In the case of FIG. 9A, a length (a radial extent) “x” of the flange section 43, which is measured in the radial direction from the connection between the flange section 43 and the flexible portion 45 at the outer peripheral surface of the flexible portion 45, is equal to or greater than two times a radius “r” of curvature of the arcuate section 42 (i.e., a radius of curvature of the imaginary arc of the arcuate surface of the arcuate section 42). Thus, the length “x” of the flange section 43 is further increased relative to a length (a radial extent) “y” of the arcuate section 42 measured from the inner peripheral surface of the flexible portion 45. By increasing the length of the flange section 43, the rigidity of the slidably engaging portion 41 against the rolling of the slidably engaging portion 41 in the rolling direction is improved. Furthermore, the flange section 43 makes surface contact with the seal wall 37 and acts as the stopper, which limits further rolling of the slidably engaging portion 41, thereby improving assembly.

Furthermore, as shown in FIG. 9B, a recess 42a can be formed at a lower part of the arcuate section 42. Even with this modification, the slidably engaging portion 41 can make point contact (or contact close to the point contact) with the joint case 33 in the cross sectional view. Thus, the effective sealing can be achieved.

Furthermore, as shown in FIG. 9C, a thick wall portion 42b can be provided in a radially inner part of the connection (the outer peripheral surface of the flexible portion 45) between the flexible portion 45 and the slidably engaging portion 41, and also a thick wall portion 43b can be provided in a radially outer part of the connection between the flexible portion 45 and the slidably engaging portion 41. The thick wall portions 42b, 43b, which project radially inwardly and radially outwardly, respectively, improve the rigidity of slidably engaging portion 41 against the rolling of the slidably engaging portion 41 in the rolling direction to limit the rolling of the slidably engaging portion 41, thereby improving the assembly. The thick wall portions 42b, 43b can be formed continuously along the entire perimeter of the connection between the slidably engaging portion 41 and the flexible portion 45 or can be intermittently formed at predetermined intervals along the perimeter or circumference of the connection between the slidably engaging portion 41 and the flexible portion 45. Furthermore, only one of the thick wall portions 42b, 43b can be provided.

In the above embodiment, the flange section 37 is continuously formed together with the slidably engaging portion 41 along the entire perimeter or circumference. However, the present invention is not limited to this. For example, the flange section 37 can be only partially formed along the perimeter.

Additional advantages and modifications will readily occur to those skilled in the art. The invention in its broader terms is therefore not limited to the specific details, representative apparatus, and illustrative examples shown and described.

What is claimed is:

1. A ball joint for rotatably connecting between a first link element and a second link element, the ball joint comprising:
a ball pin that is secured to the first link element at a base end of the ball pin;
a joint case that is secured to the second link element and is connected to a distal end of the ball pin in a manner that enables relative rotation between the first link element and the second link element; and
a boot that is installed to the base end of the ball pin and slidably engages the joint case to seal between the ball pin and the joint case, wherein:
the boot is tubular and includes:
a slidably engaging portion that slidably engages the joint case;
a connecting portion that is attached to the base end of the ball pin; and
a flexible portion that flexibly connects between the slidably engaging portion and the connecting portion and has a radial wall thickness smaller than that of the slidably engaging portion and that of the connecting portion; and
the slidably engaging portion includes:
an arcuate section that has an arcuate cross section on an inner peripheral side of the slidably engaging portion; and
a flange section that projects on an outer peripheral side of the slidably engaging portion.

2. The ball joint according to claim 1, wherein:
the joint case includes:
an installation recess that receives the distal end of the ball pin; and
a seal wall that surrounds the installation recess and projects from the installation recess; and
an outer diameter of an opening end of the seal wall is smaller than an inner diameter of the arcuate section of the slidably engaging portion of the boot.

3. The ball joint according to claim 1, wherein the flange section includes a planar surface, which extends continuously from the arcuate section toward a distal end of the flange section.

4. The ball joint according to claim 3, wherein:
the arcuate section includes an arcuate surface that extends along an imaginary arc; and
the planar surface of the flange section extends continuously from the arcuate surface of the arcuate section and is tangent to the imaginary arc of the arcuate surface of the arcuate section.

5. The ball joint according to claim 4, wherein the planar surface of the flange is tilted toward the first link element.

6. The ball joint according to claim 4, wherein a radial extent of the flange section, which is measured from an outer peripheral surface of the flexible portion, is equal to or greater than two times a radius of curvature of the imaginary arc of the arcuate surface of the arcuate section.

7. The ball joint according to claim 1, wherein a radial extent of the flange section, which is measured from an outer peripheral surface of the flexible portion, is longer than a radial extent of the arcuate section, which is measured from an inner peripheral surface of the flexible portion.

8. The ball joint according to claim 1, wherein:
a connection of the flexible portion, which is connected to the slidably engaging portion, includes at least one of a radially inner thick wall portion and a radially outer thick wall portion, each of which increases the radial wall thickness of the connection of the flexible portion in comparison to the rest of the flexible portion;
the radially inner thick wall portion projects radially inwardly from an inner peripheral surface of the flexible portion; and
the radially outer thick wall portion projects radially outwardly from an outer peripheral surface of the flexible portion.

9. The ball joint according to claim 1, wherein:
the joint case is made of resin; and
the boot is made of rubber.

10. A wiper system for wiping a windshield, the wiper system comprising:
a plurality of link elements; and
at least one ball joint, each of which rotatably connects between a first corresponding one and a second corresponding one of the plurality of link elements, wherein each ball joint includes:
a ball pin that is secured to the first corresponding one of the link elements at a base end of the ball pin;
a joint case that is secured to the second corresponding one of the link elements and is connected to a distal end of the ball pin in a manner that enables relative rotation between the first corresponding one of the link elements and the second corresponding one of the link elements; and
a boot that is installed to the base end of the ball pin and slidably engages the joint case to seal between the ball pin and the joint case, wherein:
the boot is tubular and includes:
a slidably engaging portion that slidably engages the joint case;
a connecting portion that is attached to the base end of the ball pin; and
a flexible portion that flexibly connects-between the slidably engaging portion and the connecting portion and has a radial wall thickness smaller than that of the slidably engaging portion and that of the connecting portion; and
the slidably engaging portion includes:
an arcuate section that has an arcuate cross section on an inner peripheral side of the slidably engaging portion; and
a flange section that projects on an outer peripheral side of the slidably engaging portion.

11. The wiper system according to claim 10, further comprising a wiper motor that drives the plurality of link elements, wherein:
the plurality of link elements includes:
a crank arm that is secured to an output shaft of the wiper motor;
first and second wiper rods, each of which has one end connected to the crank arm; and
first and second pivot levers, each of which is connected to the other end of a corresponding one of the first and second wiper rods;
the at least one ball joint includes first to fourth ball joints;
the first ball joint rotatably connects between the crank arm and the first wiper rod;
the second ball joint rotatably connects between the crank arm and the second wiper rod;
the third ball joint rotatably connects between the first pivot lever and the first wiper rod; and
the fourth ball joint rotatably connects between the second pivot lever and the second wiper rod.

12. The wiper system according to claim 10, wherein the flange section of the boot of each ball joint includes a planar surface, which extends continuously from the arcuate section of the boot toward a distal end of the flange section of the boot.

13. The wiper system according to claim 12, wherein:
the arcuate section includes an arcuate surface that extends along an imaginary arc; and
the planar surface of the flange section extends continuously from the arcuate surface of the arcuate section and is tangent to the imaginary arc of the arcuate surface of the arcuate section.
